(19) United States
(12) Patent Application Publication
(10) Pub. No.: US 2003/0084020 A1
(43) Pub. Date: May 1, 2003

(54) Distributed fault tolerant and secure storage

(76) Inventor: Li Shu, Billerica, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/025,113

(22) Filed: Dec. 19, 2001

Related U.S. Application Data
(60) Provisional application No. 60/258,127, filed on Dec. 22, 2000.

(51) Int. Cl. G06F 7/00

(52) U.S. Cl. 707/1

(57) ABSTRACT

The invention features an apparatus and method for facilitating reliable storage of a file. The apparatus includes a file processor that converts the file into N storage segments. The N segments enable reassembly of the file from a subset of any M of the storage segments. N and M are positive integers, and N >M≧1. The apparatus includes means facilitating storage of at least M of the N storage segments.

### CROSS-REFERENCE TO RELATED CASE

This claims the benefit of and priority to U.S. Provisional Patent Application Serial No. 60/258,127, filed Dec. 22, 2000, the entirety of which is incorporated herein by reference.

### TECHNICAL FIELD

The invention generally relates to data storage, and, more particularly, to high reliability electronic data storage.

### BACKGROUND INFORMATION

Prior methods for achieving reliable, fault tolerant storage of data include duplicating and storing copies of data in multiple systems, and the use of redundant array of independent disk (RAID) sub-systems. Failure of any one storage component, for example, a disk drive, does not compromise the integrity and the availability of the data content. The use of RAID systems provides additional protection against failure of a few of the individual storage components or devices in a system.

These approaches provide data redundancy by duplicating the entire data content in more than one system. This approach is inefficient and expensive. These deficiencies are exacerbated as the size of the data content grows.

Further, while the use of a RAID sub-system can protect data against failure of some of the storage devices in the array, it does not provide any protection against the failure of the system hosting the RAID array. Moreover, neither approach (nor their combination, which inherits disadvantages from both) provides any protection against failure of the few designated network connections utilized by data users to reach these systems.

These approaches also present a security risk. Since each system contains a complete copy of a data set, such as a file, intruders who gain access to any one system can breach the security of the entire data content. In such cases, additional data security techniques such as encryption may only delay the intruders' ability to understand and utilize the data.

### SUMMARY OF THE INVENTION

The invention generally involves data storage redundancy for storage subsystems and systems. The invention is particularly suited to distributed storage, for example, data storage that utilizes geographically distributed storage systems. The invention provides robust storage and data access while permitting reduced redundancy, i.e. duplication of data, and increased file retrieval speed. Thus, the invention enables more reliable and efficient use of resources than prior art in redundant storage methods. Further, the invention generally involves data storage that is more secure from theft and tampering than prior art in storage methods.

The above advantages are realized by splitting files to be stored, such as computer data files, into multiple storage segments, and storing the segments on storage media at distinct physical locations. The storage media can reside in a single device or multiple devices, some or all of which can be stored on geographically distributed devices. The total size of all the storage segments of a file depends on the total amount of protection desired, but is generally not more than two or three times the size of the file.

Redundancy is included in the segments without the need for numerous copies of a file, in contrast to prior art methods. The file is split according to one or more algorithms that permit reassembly of the file from just a preselected fraction of the storage segments. Such file splitting eliminates the need for complete file duplication since the loss of some segments can be tolerated. Prior art systems often require many complete duplicates of a file for backup in the event of storage system failure.

In response to a request sent to some or all of the storage devices storing segments of the file, a retriever of the file receives storage segments from various storage media locations. The file retriever can reassemble the file after receipt of the preselected fraction of storage segments. Hence, some degree of storage system failures can be tolerated without the need to resort to a complete backup copy of a file.

The preselected fraction of storage segments required for file reassembly can be chosen to accommodate a desired level of storage reliability, in light of available resources. For example, when very dependable storage systems are employed across a highly reliable and available network, the fraction can be close to one. When very undependable systems are employed, or when the reliability and availability of the network is low, the fraction may be much smaller, even less than one half or one third. The required fraction of storage segments can be selected to balance the availability of the data, and the reliability of the distributed data storage devices and the network, against a desire for efficient utilization of storage devices and a communication network.

Further, through use of geographically distributed storage, reliable storage is possible in spite of a great variety of system failures and natural or human-caused disasters. Reliable storage is maintained in spite of loss of file segments due to transmission delays, tampering or storage device failures. Files can be reliably retrieved by geographically distributed users, in spite of widespread failure of storage systems or communications networks. Rapid access to files can be maintained in spite of communication network congestion and failures.

Due to the enhanced reliability of file retrieval, confirmation of file receipt can become unnecessary. This further improves efficient use of communications network capacity.

The invention further involves enhanced file access rates. As file segments are simultaneous transmitted by their respective storage element to a receiver, and only a sufficient fraction of the file segments are necessary for the file to be successfully retrieved at the receiver, the receiver need not wait for the slowest responding storage element, whether the slowness is caused by the inherent large latency in the storage device itself, the demand on that storage device, the networking congestion and failure between the storage device and the receiver, etc, or any combination of these. Hence, a file can be retrieved more quickly than in prior art methods.

Multiple file users may simultaneously access a file. A storage device can simultaneously transmit file segments to multiple users when access to files is limited by the accessibility of storage devices rather than the availability of communications bandwidth. This is advantageous relative to systems that require serial responses to file requests from multiple requesters. To provide serial responses, requests are queued, thereby slowing file retrieval times. A simultaneous, i.e. parallel, response can enhance the speed of file retrieval.

Moreover, the invention can provide increased file security over prior art methods. An intruder may require access to more than one, or more than a few, storage devices to successfully obtain or tamper with a file. Use of encryption and scrambling techniques can further improve security.

Accordingly, in a first aspect, the invention features an apparatus for facilitating reliable storage of a file. The apparatus includes a file processor that converts the file into N storage segments. The N segments enable reassembly of the file from a subset of any M of the storage segments. N and M are positive integers, and N>M≧1. The apparatus further includes means facilitating storage of at least M of the N storage segments.

The file can be, for example, a computer data file, such as a binary data file. The processor can be, for example, a computer microprocessor integrated circuit.

The means facilitating storage may be, for example, a storage segment transmitter. The transmitter transmits the at least M storage segments to one or more storage devices. The transmitter may be an integrated circuit that transmits storage segments to storage devices via an electronic network, or may be implemented in software or firmware, e.g., as a software application, part of a computer operating system or input-output device controller. The storage segment transmitter may transmit each one of the N storage segments to one of N geographically distributed storage devices.

The apparatus may include a storage segment retriever and a file reassembler. The retriever requests at least M storage segments from the storage device(s). The file reassembler reassembles the file after receiving as few as M of the N storage segments. The retriever and the reassembler may be, for example, one or more integrated circuits or implemented in software or firmware.

In a second aspect, the invention features a method of facilitating reliable storage of a file. The method includes converting the file into N storage segments. The N segments enable reassembly of the file from a subset of any M of the storage segments. N and M are positive integers, and N>M≧1. The method further includes storing at least M of the N storage segments.

The method may include retrieving at least M of the N storage segments and reassembling the file from the retrieved storage segments. Storing at least M of the N storage segments may include transmitting the at least M storage segments to one or more storage devices. In this case, retrieving at least M of the N storage segments includes transmitting a request for storage segments of the file to the one or more storage devices.

Requests for the storage segments of a file, for example, may be originated by the requester of the file directly, or may be originated by a file server in response to the requester of the file. In the latter case, the knowledge of the location of the storage devices, and knowledge of the set of storage devices hosting the storage segments for a particular file, may be contained in the file server.

When a file server stores information about storage segment location, a file requester need not maintain knowledge regarding which storage devices host the storage segments for a file. Further the data storage devices may need to maintain knowledge about the association between hosted storage segments and their corresponding file. Additional protection of data against intrusion and theft may thus accrue because obtaining access to all the data storage devices may be insufficient to enable reconstruction of the data without the knowledge maintained in the file server.

Transmitting the at least M storage segments may include transmitting the N storage segments to N storage devices. In another alternative, transmitting the at least M storage segments may include transmitting the N storage segments to N geographically distributed storage devices.

It should be understood that the term “transmitting” is intended to broadly connote all suitable techniques of file transfer, including, but not limited to, standard storage and file-transfer protocols applied locally (e.g. within a single computer) or to distributed devices on a computer network using physical and/or wireless media.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an embodiment of the construction and distribution of the storage segments of a file, and reassembly of the file from the storage segments.

FIG. 2 illustrates an embodiment of a forwarding of a data file in response to a request that provides improved data security in transit.

FIG. 3 illustrates an embodiment of a method that converts a data file into its storage segments.

FIG. 4 illustrates an embodiment of spatial diversification of data transmission, which transmits split storage segments along three paths through a network.

FIG. 5 illustrates an embodiment of reassembly of a file by a requester.

FIG. 6 illustrates an embodiment where obstructing the transmission of a single storage segment does not affect the reconstruction of the data file by a requester.

FIG. 7 illustrates an embodiment where obtaining a single storage segment of a file by eavesdropping on a single link of the network provides no information on the file.

FIG. 8 illustrates an embodiment with integration of data encryption into an encoder and a decoder.

FIG. 9 illustrates an embodiment with integration of data encryption into the splitter and the assembler.

FIG. 10 illustrates an embodiment of an apparatus for transmitting a file via a communications network.

FIG. 11 illustrates an embodiment of N message segment identifiers attached to N message segments.

FIG. 12 illustrates an embodiment of an apparatus for facilitating reliable storage of a file.

FIG. 13 illustrates a portion of an embodiment of an apparatus for facilitating reliable storage of a file that includes a storage segment retriever and a file reassembler.

FIG. 14 illustrates the functioning of an embodiment of an apparatus for facilitating reliable storage, which stores files on a single storage device.

FIG. 15 illustrates the functioning of an embodiment of an apparatus for facilitating reliable storage, which stores files on three storage devices.

FIG. 16 illustrated one embodiment of the storage and retrieval of a file.

### DESCRIPTION

The terms “file”, “message”, “data” and “data file” are herein understood to refer to any entity of data that may be stored and/or transferred via analog or digital means. The entity may originate in analog or digital form, and, at various times, may be stored in analog or digital form. The entity is capable of storage in electronic, electro-magnetic, electro-optic, optic, quantum, and other means, and is capable of transfer between two distinct physical locations via, in particular, electronic, wireless and optically based communications.

Although the present invention is directed primarily toward information storage and retrieval, the underlying approach of the invention, as well as its benefits and operation, are also apparent in the context of message transmission and routing. Accordingly, for purposes of explanation, the following section, labeled “I”, describes file splitting and reassembly in the context of communications. The subsequent section, labeled “II”, then describes the application of file splitting and reassembly to file storage.

I. File Splitting and Spatially Diversified Storage Segment Routing for File Transmission Assurance and Data Security Over Distributed Networks

An apparatus and method for data assurance in communication networks, preferably mobile ad-hoc networks (MANETs), makes advantageous use of features of networked communications. During a typical communications session (between, e.g., an originating node and a destination node), messages can be forwarded along multiple, variable data paths. Aggregation of a number of such paths forms a single “super path.” In one embodiment, a method includes encoding a message, splitting the encoded result into distinct message segments, and sending each segment along a different path. A receiving node may reconstruct the original message without the requirement that all message segments eventually reach the receiving node after traveling along their individual paths.

One embodiment includes a protocol that enables a sender to provide information to a destination, i.e., receiver node, about encoding and splitting algorithms that were used to process a message. Some embodiments include methods for inferring the status of the collection of links. Some embodiments include one or more algorithms for determining which combination of encoding and splitting algorithms to use in response to a current status of the links.

Hence, some embodiments enable dynamic adjustment in response to changing network communication conditions. One such embodiment includes a set of encoding/decoding algorithms and a set of splitting/reassembling algorithms to permit an optimized response to the dynamic variations in the link characteristics. Modified algorithms can incorporate data security enhancement features.

For example, encoding algorithms may be used to prevent the deduction of any part of the original message from individual processed message segments. A minimum number of message segments may be required to reconstruct the original message. Further, encryption keys may be used to enhance security. In particular, security enhancement can be achieved by deterministically varying a set of splitting/reassembling algorithms.

Data assurance in MANETs can be adjusted to a desired level by choosing an appropriate encoding and splitting scheme to tolerate failures over a sufficiently large number of paths. Encoding redundancy can reduce or eliminate the need for message retransmission. Message delay may be reduced, and utilization of each link in the network may be increased. Generally, the benefit in overall network resource utilization and performance grows with the number of links, i.e., the number of directly communicating node-pair combinations, and the expected number of relaying hops through which a packet is forwarded towards its destination.

In one aspect, the apparatus and method improve data security. As multiple message segments are required to decode the original message, an eavesdropper sniffing, e.g., packets traveling on a particular path cannot deduce much useful information. Additional security components or steps can improve the level of data security; for example, encoding mechanisms can be chosen to avoid exposing the original data bits directly and a bit-position scrambling mechanism can be incorporated before splitting of the message. This provides security gains that require almost no increase in system complexity or computational burden.

In one embodiment, a redundantly encoded message is transmitted by aggregating multiple paths in a MANET to form a single super-path. This aggregation provides robustness in view of the potentially drastic variation in individual links. The super-path has a collective characteristic that improves stability, and statistically resembles a fixed link pathway in comparison to a pathway through a conventional MANET.

The channel coding technique may first encode the message to inject the desired level of redundancy into the message, then split the encoded message into multiple segments, and then forward each segment along a different path. At the receiving end, the extra redundancy injected by the encoding method (via, e.g., erasure correcting codes) may permit reassembly of the original message without requiring the successful delivery of all message segments through their individual paths.

Encoding methods may be used to improve the data assurance to a desired level for a MANET. This is more effective for MANET-based communications than simply adopting or adapting the two-pronged approach of fixed point-to-point channels (and conventional networks). The characteristics of the aggregated super-path more closely resemble that of the fixed point-to-point channel than that of the individual member paths in the aggregate. Moreover, the variation in the characteristics of the super-path is slower than the variation of individual member paths, and can be designed to become tractable.

As a result, the variation of super-path characteristics can become more sensitive to network communications congestion than to link-to-link communication variations, e.g., radio frequency channel variations, arising from movement of the nodes. Hence, in one embodiment, super-path characteristics are regularly or continuously analyzed, and encoding and splitting algorithms are selected from classes of encoding algorithms and splitting algorithms in response to a determined characteristic. Super-path characteristics may include, for example, the number of successfully received message segments and the identity of the paths through which message segments are successfully received.

The performance of these classes of algorithms can be rated. Protocols that implement measurement of super-path characteristics and dynamic selection of an optimum combination of encoding algorithms and splitting algorithms can also be rated. Rating of algorithms and protocols can permit improved optimization of selections.

Encoding and splitting of messages directly improves message security. Because the message segments are forwarded along distinct routes to the destination, an eavesdropper must simultaneously intercept multiple message segments before a successful recovery of the original message becomes possible. The mobility and the geographical distribution of the nodes in the network make this difficult, and splitting the message into more segments can increase the difficulty of recovery. Furthermore, an encoding algorithm can be chosen that prevents message reconstruction without interception of at least a threshold portion of message segments.

Additional security is made possible by scrambling, even simple scrambling, of the positions of the encoded message bits, e.g. before splitting, to prevent message reconstruction by an eavesdropper even when the eavesdropper intercepts a sufficiently large number of message segments. Generally, scrambling and de-scrambling of bit positions requires many fewer operations to execute and complete than traditional encryption and decryption methods.

Some embodiments include a stand-alone protocol layer for insertion in the networking protocol layer. For example, the protocol layer can be inserted between the medium access control (MAC) layer and the networking layer of a communication system. The protocol layer may include mechanisms for monitoring or analyzing the characteristics of network links and a decision algorithm to dynamically choose one of a class of encoding and splitting algorithms based on the observed network link characteristics.

In one embodiment, when the link stability is low, the protocol layer switches to an encoding algorithm that tolerates more losses of the message segments and a message-splitting scheme that results in smaller segments, in an attempt to improve delivery assurance. In another embodiment, when the link stability improves, the protocol layer switches to an encoding algorithm that has requires more message segments to be received and a message-splitting scheme that uses larger segments, in an attempt to reduce the protocol overhead.

The impact of the proposed algorithm and the dynamic protocol can be measured at multiple levels of the network. The probability of delivery success in a single attempt can be improved to any desired level by choosing an appropriate combination of encoding and splitting methods or algorithms.

Generally, an entire message is not transmitted along a single path. Instead, a message is fragmented, i.e. split, and forwarded along multiple paths. The realized increase in data assurance general comes with an initial delay in transmission of message segments, or packets, due to the encoding and splitting. Generally, however, overall communications delays are improved because of the improved probability of completion of each message transmission in the first attempt.

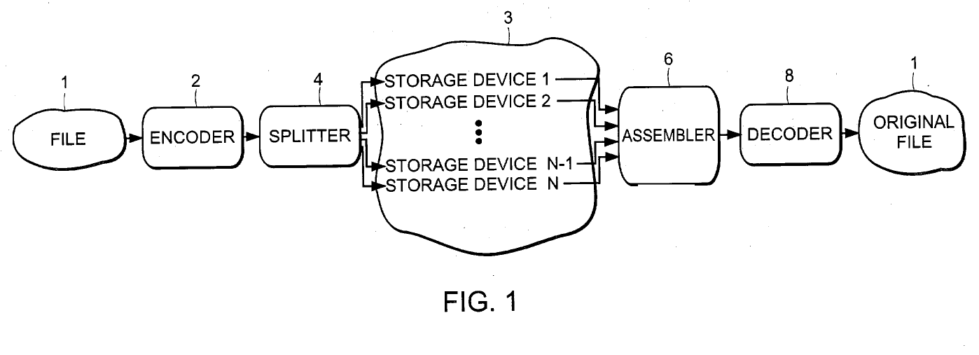

Referring to FIG. 1, an embodiment of storage and retrieval of a file is illustrated. A file 1, e.g., a block of file bits, is fed to an encoder 2, e.g. a scrambling encoder. The encoder 2 injects redundancy into the file bit stream, which increases the number of bits in the file. The encoded file is fed to a file splitter 4, which breaks the file into N storage segments.

The N storage segments are forwarded to the N storage devices 3 along different paths through a network. The N storage segments are later forwarded from the N storage devices 3 to a file requester. An assembler 6 reassembles the encoded file as the segments are received. When the number of segments received reaches a specified threshold, a partially reassembled file is passed to a decoder 8, e.g. an erasure decoder. The decoder recovers the original file 1, using only the bits available from the partially assembled file. The threshold number of segments is determined by the selected coding scheme. Both the assembler 6 and the erasure decoder 8 may be implemented in hardware and/or as software modules.

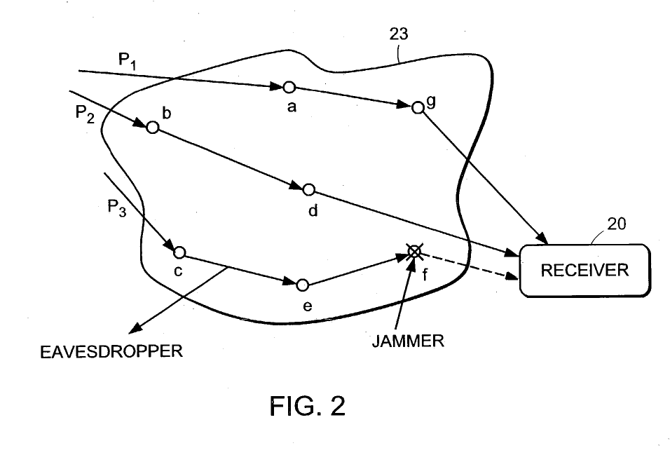

FIG. 2 illustrates an embodiment that provides improved file security. Storage devices, associated with network nodes a, b, c and a receiver 20 agree to use a combination of an encoding scheme and a splitting mechanism for a file split into three storage segments for transmission via a network nodes e, d, g. The encoding scheme requires at least two storage segments to reach the receiver for recovery of a split file.

An eavesdropper is illustrated as intercepting file segments between nodes c and e; a jammer is illustrated as blocking transmission of file segments at node f. Three paths P₁, P₂, P₃ through the network 23 are a subset of all possible paths. File security and integrity are maintained in spite of the efforts of the eavesdropper and the jammer.

The eavesdropper acquires only a storage segment transmitted along path P₃. Because the number of file segments threshold is 2, the single segment does not provide any useful information to the eavesdropper. All three segments will reach the receiver 20. The first two to arrive are used to reassemble the original message.

The jammer attacking node f prevents the file segment traveling on path P₃ from reaching the receiver 20. The other two file segments, however, arrive, and the file is recovered. The jammer cannot prevent the receiver 20 from getting the file.

Several criteria may be used to assess the performance of alternative implementations of a decision algorithm and a dynamic protocol. Such criteria may include, for example:

delivery assurance, the probability of successful receipt of a fully correct file (affected by the probability of link/node failure);

security improvement, in terms of the number of file segments that must be acquired by an eavesdropper in order to reconstruct the original file; and

improvement in effective bandwidth, the reduction in the number of required retransmissions as compared to, for example, a two-pronged approach.

In one embodiment, a protocol is inserted into a network communications protocol stack, e.g., between the MAC and the networking layer. This protocol mechanism senses and predicts variations in the characteristics of the link aggregate, and dynamically chooses the best combination of encoding/decoding and splitting/reassembly algorithms from a set or class of algorithms. The attempt to optimize can seek a combination that adds the least overhead to achieve a specified probability of successful file delivery. The selection process may further include, e.g., consideration of file priority, other measures of file importance, or cost of latency.

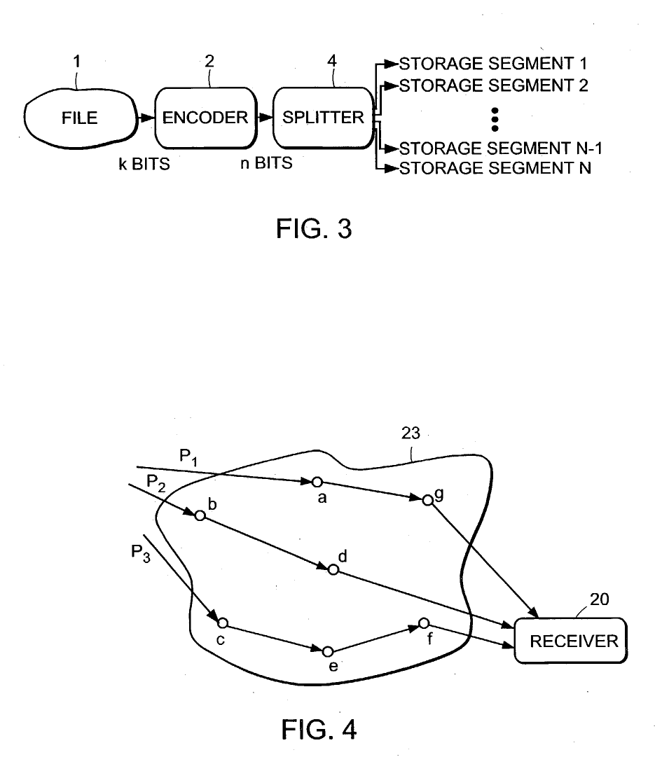

Referring to FIG. 3, one embodiment is illustrated of a method that provides file delivery assurance and security. The method includes encoding the file to inject redundancy into a file stream, and splitting the encoded file. The split, encoded file is forwarded along spatially diversified routes.

For example, a file, or file block, that includes k bits is processed through an encoder 2, e.g., a scrambling encoder, that converts the file into an encoded file block of n bits, where n>k. A splitter 4 decomposes the output of the encoder 2 into N file segments, each segment including no more than [n/N] bits. “[n/N]” denotes the least integer greater than n/N. N, n and k are positive integers.

FIG. 4 illustrates spatial diversification. Each of the N file segments is forwarded to the intended recipient, preferably along a different route. This gives spatial diversification to the routes used for transmission. Nodes a-g are a subset of network 23 nodes. Storage segments are forwarded to the receiver 20, i.e., a file requester, along path P₁ (including nodes a and g), path P₂ (including nodes b and d), and path P₃ (nodes c, e, and f). The different physical locations of the nodes force the file segments to travel through different areas of the network 23. Link conditions and congestion in different areas may vary considerably.

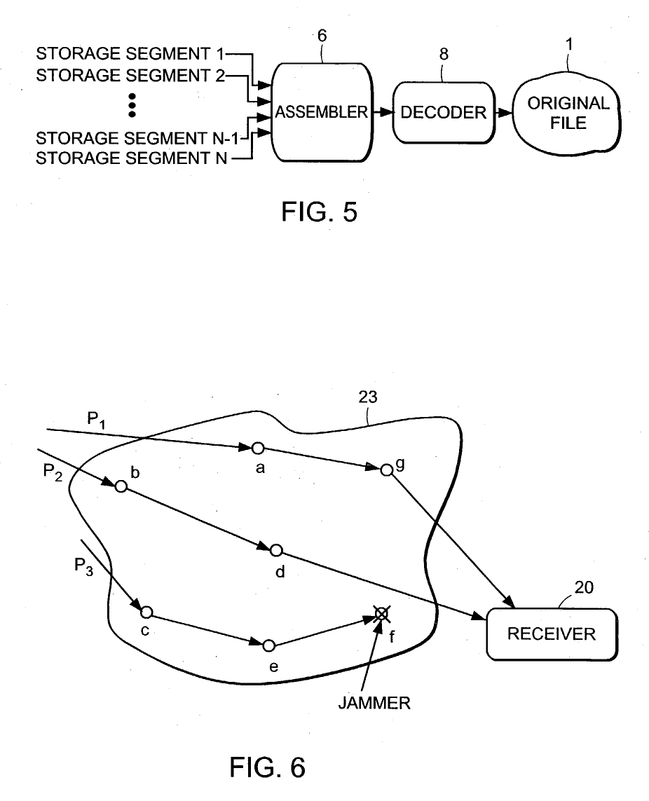

Referring to FIG. 5, in one embodiment, N storage segments are re-assembled as they are received by a receiver. When a sufficiently large number of file segments are received, the partially assembled file is forwarded to a decoder 8, e.g., an erasure decoder, which recovers the entire original file. Improved delivery assurance is achieved because not all file segments must be successfully received to permit the recipient to recover the original file.

In one embodiment, each file segment has a length of b, where 0<b≦[n/N]. “[n/N]” denotes the least integer greater than n/N. Limitation of the value of b can assure that each encoded file bit exists in only one file segment. Because n must be greater than k, [k/b]<N. Hence, there are fewer than N segments when the shorter unencoded file is broken into segments of length b. A longer, encoded file is obtained with N segments of length b.

The intended recipient can recover the original file with any subset of [k/b] segments of the N file segments, given an appropriate selection of the encoding scheme. Hence, the file recovery mechanism at the intended recipient can tolerate the loss of some of the file segments. This allows for losses due to, e.g., network congestion, broken links, interference or jamming. This may require n bits to be transmitted for every k file bits, where n>k. Advantages are realized, however, such as:

n/k may be smaller than the number of bits that would be transmitted for each bit if an entire block is retransmitted; and

the probability that the intended recipient correctly recovers the original file from a single transmission attempt is improved.

Examples of classes of error-correcting codes that can be utilized include Bose-Chaudhuri-Hocquenghem (BCH) codes, Convolutional codes, Hamming codes, Reed-Solomon codes, Golay codes, Turbo codes, and several other linear and nonlinear block codes.

Various embodiments provide significant security benefits. Referring to FIG. 6, resistance to localized jamming is one benefit. Jamming, for example, disrupting transmission at a single network node or link, minimally impacts the functionality of the rest of the network. When a jammer located near node f has broken the continuity of path P₃, path P₁ and path P₂ are still able to deliver file segments, and the file is successfully decoded. To be effective at disruption, a jammer must be located close enough to either the sender 10 or receiver 20 to jam a significant number of file segments. For example, the probability of disruption in a mobile, military network is reduced by the requirement for close proximity of a hostile jammer.

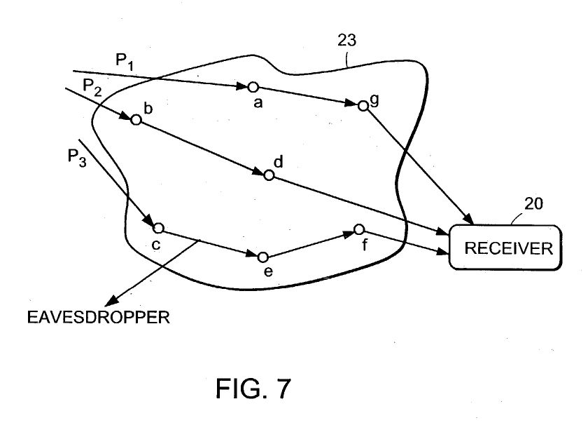

Referring to FIG. 7, another security benefit of some embodiments is the difficulty an eavesdropper experiences when trying to intercept files. As illustrated in FIG. 7, an eavesdropper is physically located between node c and node e, able to copy any file segment, e.g., data packet, that passes along path P₃. The eavesdropper must correctly receive a minimum of [k/b] file segments to recover a complete file. To receive the minimum number of segments, however, requires eavesdropping on other paths P₁, P₂.

Some embodiments prevent even partial file recovery by the eavesdropper. An appropriately chosen scrambling encoder (e.g., a non-systematic code) can be used to create a condition during which any subset of q file segments, with q<[k/b], will prove insufficient to recover any subset of the original file. Similar to the jammer, the eavesdropper must be physically located very close to either the sender 10 or the intended recipient 20 to effectively intercept segments from multiple paths P₁, P₂, P₃.

The effectiveness of a local jammer is reduced by taking advantage of the nature of a distributed networking environment. Similarly, a single eavesdropper has a reduced ability to observe enough segments to allow an understanding of the communications carried by the network. As a result, the overall security of information carried by the entire network is significantly improved.

Some embodiments further improve security through use of data encryption by means of bit position scrambling. The selection of a scrambling encoder can be controlled with an encryption key. In some alternative embodiments, the actual bit scrambling can be accomplished in either an encoder or a splitter.

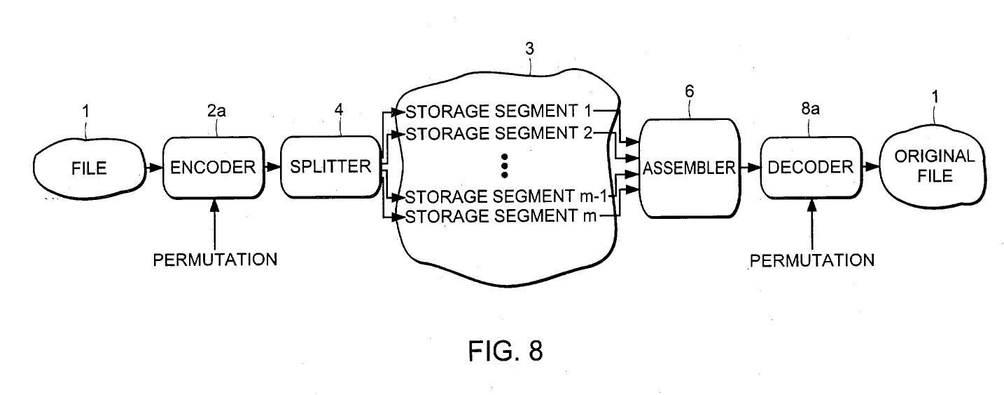

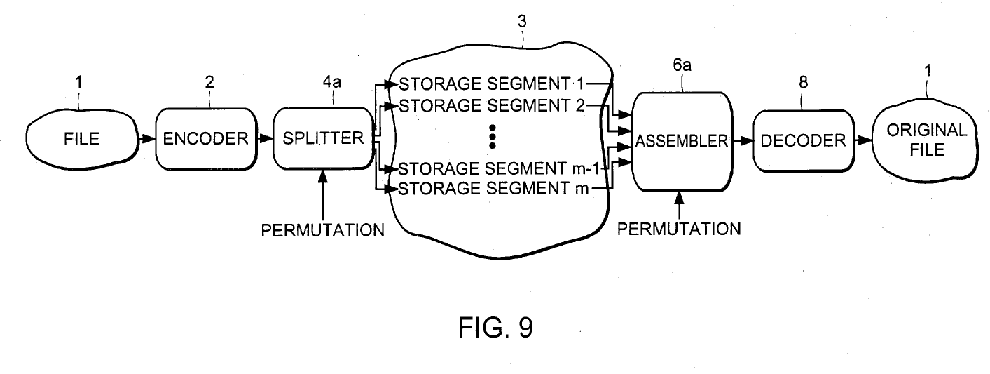

Referring to FIGS. 8 and 9, embodiments that utilize permutation are illustrated. FIG. 8 schematically shows the use of permutation by an encoder 2a. FIG. 9 shows the use of permutation by a splitter 4a. For example, even a simple use of an encryption key to alter bit positions in the encoded message, would require the eavesdropper to potentially search through n! possibilities.

Some embodiments that include a scrambling encoder employ an encoding scheme that provides one or both of the following features:

the encoding scheme provides strong resilience against loss of file segments, preferably having the value of (k+e) as close to n as possible, where e is the number of file segment losses that the scheme can overcome, k is the original file length, and n is the encoded file length; and

no bits in the original file are ascertainable from any file subset below a threshold number; for linear block codes, this generally requires use of non-systematic codes and that approximately half of the elements of a generating matrix elements have a value of 1.

In order for the assembler at the receiving node to correctly reassemble the file fragments, the content of each segment must be identified. In one embodiment, the information required for reassembly is reduced by inclusion of a numbering scheme for the file segments. In a preferred embodiment, a segment carries identification that is a number assigned by the file splitter. This number may be a field in a protocol header that is attached to each file segment, or embedded in the file segment itself.

Additional protocol header fields may be included when encoding and splitting algorithms are altered dynamically to better suit the observed characteristic variations of the super-path. The additional fields can carry measurement data regarding the characteristics of the super-path as well as data that informs the destination node of the changes in the encoding and splitting algorithms. Inclusion of additional protocol header fields incurs additional transmission bandwidth for every hop. Hence, it is preferable to optimize choices of fields to minimize the resulting bandwidth expansion.

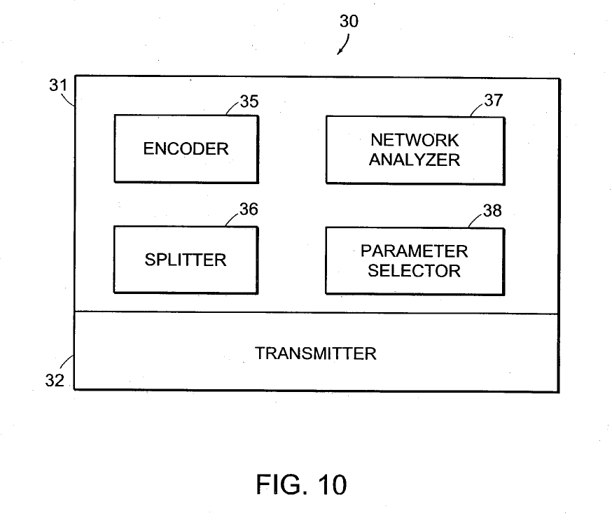

Referring to FIG. 10, an embodiment of an apparatus 30 for transmitting a file via a communications network is illustrated. The apparatus 30 includes a file processor 31, which may be implemented in hardware and/or as a software module, and a file segment transmitter 32. The file processor converts files into N file segments that enable reassembly of the file from a subset of any M of the file segments. N and M are positive integers and N>M≧1.

The file segment transmitter 32, which may be implemented in hardware and/or as a software module, transmits file segments to a receiver. The receiver can reassemble a file after receiving M of the N file segments.

The file processor 31 may comprise a file encoder 35 and an encoded file splitter 36 that convert a file into N file segments. The file encoder 35 may implement a class of encoding algorithms in generating the file segments. The encoded file splitter 36 may implement a class of splitting algorithms.

The processor 31 may further comprise a communications network analyzer 37, which may be implemented in hardware and/or as a software module, that determines the condition of a communications network. The processor 31 may also include a file segment parameter selector 38 (which also may be implemented in hardware and/or as a software module) that selects a set of values for M and N based on the determined condition to achieve a preselected probability of a successful transmission of M of the transmitted file segments.

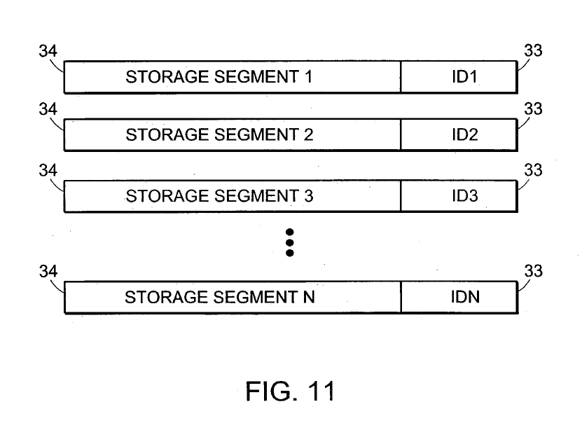

Referring to FIG. 11, an apparatus may include N file segment identifiers 33 that have a one-to-one association with the N storage segments 34. In the embodiment illustrated in FIG. 11, storage segments 34 are transmitted with their associated identifiers 33 to assist in reassembly of the file. The identifiers 33 can include, for example alphanumeric data. In one embodiment, during transmission, the identifiers 33 are binary numbers.

The above described and various other embodiments may be applied to, for example, networks that carry packet transmissions using distributed routing algorithms.

II. Distributed Fault Tolerant and Secure Storage

Various embodiments of an apparatus and method support data redundancy across storage subsystems, across systems, and across networks. Some embodiments provide extremely high levels of fault tolerant data storage. Message or data files are broken into multiple pieces and stored on distinct sections of physical media, distinct physically co-located media, or physical media that are located across geographically distributed, even globally distributed, areas linked across a network. Protection is provided against, for example, disk subsystem failure, system failure and individual network connection failure, as well as failure of significant portions of an entire network.

Some embodiments make use of the techniques described in Section I above to split and reassemble data, respectively before and after storage. For example, a data file in the form of a block of k bits is processed through a scrambling encoder, which converts the block of k bits into a block of n bits. A message splitter splits the output of the scrambling encoder into N data pieces, i.e. storage segments, each including preferably no more than n/N bits.

Each of the storage segments is then forwarded and stored on storage media that may be physically located anywhere, even globally distributed. In one embodiment, the storage segments are stored on distinct portions of a single storage disk. When the file is required by a user, who may or may not be the same user that stored the file, the user posts a message to all storage elements, in the network. Upon receipt of the message, each storage element hosting at least one of the storage segments forwards the storage segment towards the requester. Once the requester receives a sufficient number of segments, the received segments are reassembled and erasure decoding is performed to recover the original data file.

Alternatively, a file server is dedicated to maintain the knowledge of the list of storage devices that contains the storage segments for each of the files, so that requests for the files are directed to the file server. The file server then posts messages to these storage devices, which request that the file servers forward the relevant storage segments to the requester.

Several advantages exist over prior data storage techniques. In one embodiment, data pieces can be stored over a physically widely distributed network. Failure of a potentially large number of systems on the network will not affect the integrity or availability of the original data file. Further, failure of a significant section of the network, for example due to congestion or broken links, generally will not affect the integrity nor the availability of the original data file. When file access is limited by individual storage device access rather than network bandwidth, use of multiple storage devices to retrieve multiple segments simultaneously improves data access speeds.

In one embodiment, transmission of storage segments from storage elements in response to a retrieval request need not be acknowledged due to the extremely high reliability and availability of the data. In rare cases, when the number of received segments does not exceed the required threshold, the requester can re-post a file request along with a list of already received segments to instruct the storage elements not to resend those segments. The resulting network communications are more efficient due to elimination of acknowledgement transmissions. Further, the network provides better reliability of file retrieval in terms of successful delivery upon a first request.

Various embodiments provide highly reliable storage without resort to the degree of redundancy of prior art methods. For example, for a selection of encoding and splitting algorithms that permit reassembly of a file from one-half of the segments, the total amount of storage space required from all participating systems need not exceed two to three times that required for the original data file. This permits, for example, the failure of nearly half of the storage devices, or the failure of nearly half of the network connections to the storage devices, without affecting the availability or the reliability of the data. Hence, excellent stored data availability and reliability may be achieved with only a moderate amount of extra data storage.

Some embodiments improve security of the data by not storing any raw data. In such cases, an intruder who has gained physical access to a single system or even a few systems may not recover any part of the original data content.

In another embodiment, a file server is dedicated to the maintenance of knowledge of the list of storage devices that contain storage segments for each file. Requests for the files may be directed to the file server. The dedicated file server then posts messages to the storage devices, requesting them to forward the relevant storage segments to the requester.

The dedicated file server may further hold knowledge regarding the identities of the storage segments on the storage devices, so that, in response to the message segment request, the file server may post messages to each storage device to instruct each of them to send the particular storage segment to the requester. Thus, without the knowledge contained in the file server, an intruder would be unable to associate the appropriate storage segments with their respective files even if the intruder were able to gain access to all storage devices.

In another embodiment, the data is encrypted before splitting, and decrypted after reassembly and recovery. In another embodiment, a permutation key is implemented by the scrambling encoder and erasure decoder in any or some combination of the following ways: scrambling the positions of the original data file; scrambling the positions of the encoded data before splitting; and choosing one out of a class of distinct scrambling encoders, and thus the required decoders. Further, these two embodiments can be combined. The method further provides for good security even without use of conventional data encryption techniques.

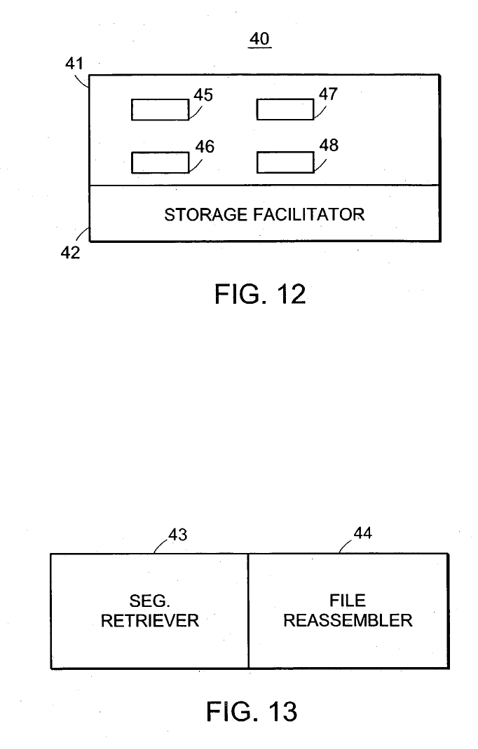

Referring to FIG. 12, an embodiment of an apparatus 40 for facilitating reliable storage of a file includes a file processor 41 and means 42 facilitating storage. The file processor 41 converts a file into N storage segments that enable reassembly of the file from a subset of any M of the storage segments. M and N are positive integers.

The means facilitating storage may be, for example, a storage segment transmitter that transmits storage segments to storage devices. The means facilitating storage may be, for example, standard file storage protocols for storing a file on any computer-related storage media, for example, a magnetic or optical disk system, a magnetic tape system, or solid state memory.

In one embodiment, the file processor 41 includes a file encoder 45 and an encoded file splitter 46 that convert a file into N message segments. The file encoder 45 may implement a class of encoding algorithms in generating the message segments. The encoded file splitter 46 may implement a class of splitting algorithms.

Referring to FIG. 13, in some embodiments, the apparatus further includes a storage segment retriever 43 and a file reassembler 44, both of which may be implemented in hardware and/or as software modules. The storage segment retriever 43 requests at least M storage segments from storage devices storing storage segments. The file reassembler 44 reassembles the file after receiving as few as M of the N storage segments.

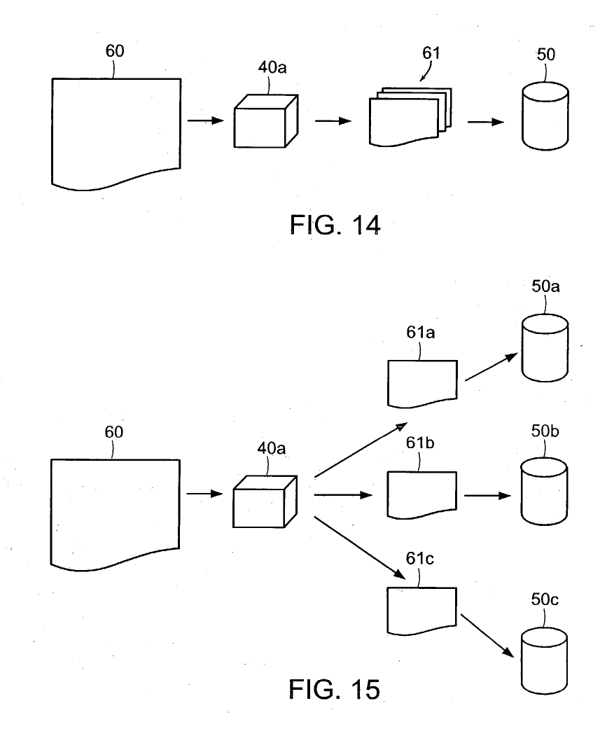

Referring to FIG. 14 and FIG. 15, the functioning of an apparatus for facilitating reliable storage is schematically illustrated in two embodiments. Referring to FIG. 14, an apparatus 40a converts a data file 60 into three storage segments 61. The storage segments 61 are stored on a single storage device 50. The storage device 50 may be, for example, a single or multiple disk-based storage system. The apparatus 40a and storage system 50 may be included in a single computing device, for example, a personal computer.

Referring to FIG. 15, an apparatus 40b converts a data file 60 into three storage segments 61a, 61b, 61c. Each of the three storage segments 61a, 61b, 61c is stored on a different storage device 50a, 50b, 50c. The three storage devices 61a, 61b, 61c may be, for example, privately used by the apparatus 40b, or accessed via a shared network such as a local-area network (“LAN”) or wide-area network (“WAN”), e.g., the Internet.

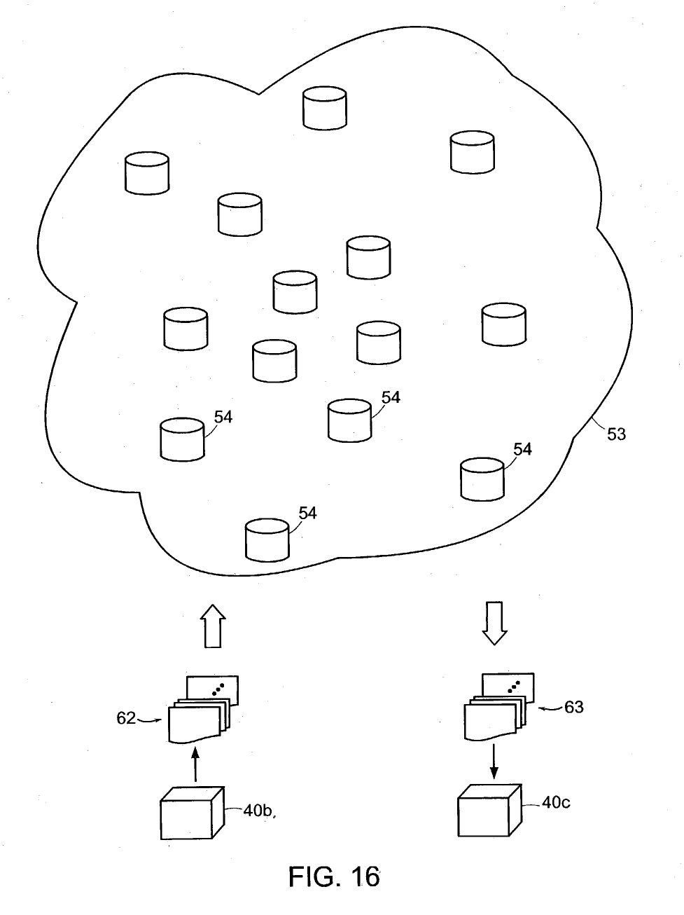

Referring to FIG. 16, one embodiment of the storage and retrieval of a file is illustrated. An apparatus 40b converts a file into N storage segments 62. The N storage segments 62 are transmitted via a network 53 for storage at storage devices 54. An apparatus 40c receives at least M storage segments 63 in response to posting a request for the file. The apparatus 40c then reassembles the file.

Some embodiments include two or more stages of file splitting. In these embodiments, one or more storage segments from a first file splitting step may be further split into additional storage segments. A second splitting step may be advantageous, for example, when a node that transmits files via a network, for storage, has limited access to the network. For example, a node that transmits files via the Internet may have limited gateway access. The access may be limited, for example, to as few as one or two gateways.

The node might then split a file into a few storage segments, for example three storage segments, and transmit the storage segments to the gateways. The gateways could further split one or more of the three storage segments, and then forward storage segments toward a receiver via the Internet.

In some embodiments of a method for facilitating reliable storage of a file, which include multiple splitting steps, the file is converted into N storage segments that enable reassembly of the file from a subset of any M of the storage segments. At least M of the N storage segments are stored.

Prior to storage, at least one of the storage segments is further converted into N₂ storage segments that enable reassembly of the at least one storage segment from a subset of any M₂ of the N₂ storage segments. As for N and M, N₂ and M₂ are positive integers and N₂>M₂≧1. At least M₂ of the stored at least M₂ storage segments are retrieved for reassembly of the at least one message segment prior to reassembly of the file.

The at least M₂ segments may be reassembled by the file retriever. Alternatively, the at least M₂ segments may be received and reassembled by an intermediate node. The reassembled segment may then be transmitted toward the retriever. Additional conversion steps and/or reassembly steps may be included at intermediate nodes in a transmission network.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. An apparatus for facilitating reliable storage of a file, comprising:
a file processor for converting the file into N storage segments that enable reassembly of the file from a subset of any M of the storage segments, where N and M are positive integers, and
N>M≧1; and
means facilitating storage of at least M of the N storage segments.

2. The apparatus of claim 1 wherein the means facilitating storage is a storage segment transmitter that transmits at least M storage segments toward one or more storage devices.

3. The apparatus of claim 2 further comprising a storage segment retriever that requests the at least M storage segments from the one or more storage devices, and a file reassembler that reassembles the file after receiving as few as M of the N storage segments.

4. The apparatus of claim 2 wherein the storage segment transmitter transmits each one of the N storage segments to one of N geographically distributed storage devices.

5. A method of facilitating reliable storage of a file, comprising the steps of:
converting the file into N storage segments that enable reassembly of the file from a subset of any M of the storage segments, where N and M are positive integers, and
N>M≧1; and
storing at least M of the N storage segments.

6. The method of claim 5 further comprising the steps of retrieving at least M of the N storage segments and reassembling the file from the retrieved storage segments.

7. The method of claim 6 wherein the step of storing comprises transmitting at least M storage segments toward one or more storage devices, and the step of retrieving comprises transmitting a request for storage segments of the file to the one or more storage devices.

8. The method of claim 7 wherein the step of transmitting at least M storage segments comprises transmitting the N storage segments to N storage devices.

9. The method of claim 7 wherein the step of transmitting at least M storage segments comprises transmitting the N storage segments to N geographically distributed storage devices.

10. The method of claim 6 wherein the step of storing comprises transmitting at least M storage segments to one or more storage devices of a plurality of network devices, and the step of retrieving comprises transmitting to a server a request for storage segments of the file, wherein the server posts messages to the one or more storage devices requesting the one or more storage devices to transmit storage segments of the file to a requester.

11. The method of claim 10 further comprising the step of storing, at the server, identity information about the plurality of network devices to impede an intruder from learning the identity information about the plurality of storage devices.

12. The method of claim 10 further comprising the step of storing, at the server, identity information about the one or more storage devices storing the at least M storage segments to impede an intruder from learning the identity information about the one or more storage devices.

13. The method of claim 5 further comprising the step of causing conversion of at least one of the M storage segments into N₂ storage segments that enable reassembly of the at least one storage segment from a subset of any M₂ of the N₂ message segments, where N₂ and M₂ are positive integers and N₂>M₂≧1; and wherein the step of storing at least M of the N storage segments comprises storing at least M₂ of the N₂ message segments.

14. The method of claim 13 wherein the step of causing conversion of at least one of the M storage segments comprises causing conversion by a node, and wherein the step of storing further comprises: transmitting the at least one of the M storage segments to the node; and causing the node to transmit the at least M₂ storage segments to one or more storage devices.

15. The method of claim 14 further comprising the steps of: causing retrieval of at least M₂ of the N₂ storage segments; and reassembling the at least one of the M storage segments before reassembling the file from at least M of the N storage segments.
